(19) United States
(12) Patent Application Publication
(10) Pub. No.: US 2005/0187779 A1
(43) Pub. Date: Aug. 25, 2005

(54) Method for providing products and information related to funerals directly to a consumer

(76) Inventors: Michael Rybarski, Houston, TX (US); Glenn Massey, Houston, TX (US); David F. Gow, Houston, TX (US); R. Douglas Parker, Houston, TX (US)

Correspondence Address: BUSKOP LAW GROUP, P.C., 1776 YORKTOWN, SUITE 550, HOUSTON, TX, 77056, US

(21) Appl. No.: 10/785,743

(22) Filed: Feb. 24, 2004

(51) Int. Cl. G06F 17/60

(52) U.S. Cl. 705/1; 705/14; 705/26

(57) ABSTRACT

The method for providing products and advice related to funerals directly to a consumer entails providing products to a consumer; providing advice to the consumer, such as funeral planning and funeral financing, by a website, direct mail, television, radio, hospice referral, minister referral, affinity group referral, or combinations thereof; receiving a consumer communication about the product, the advice, or both; processing the consumer communication; providing optional secondary advice to the consumer; receiving payment from the consumer; processing the payment; providing the products or advice to a location or person designated by the consumer; and providing follow-up contact after the product or advice is delivered.

### FIELD

The method relates to a manner for providing products and advice and funeral plan design related to funerals directly to a consumer.

### BACKGROUND

The funeral industry is a highly regulated, but highly profitable industry. Many consumers are daunted by the over $5000 in costs that the average American funeral requires.

A need has existed for a direct-to-consumer system that can directly link consumers to the funeral products and provide live or interactive advice about funerals. The products and advice need to be delivered at a lower cost than is currently available commercially.

### SUMMARY

The method for providing products and advice related to funerals directly to a consumer entails providing products to the consumer, such as caskets, markers, and cremation urns simultaneously with live or interactive advice on planning and managing a funeral. The method entails providing advice to consumers, such as funeral ceremony planning advice; funeral ceremony financing advice; and combinations thereof; wherein the advice is provided from a website, by phone, via a chat room, or otherwise.

The method entails receiving a consumer communication and processing the consumer communication. Secondary or additional advice can also be given to the customer and the family of the customer.

### DETAILED DESCRIPTION OF THE PREFERRED EMBODIMENTS

Before explaining the present system in detail, it is to be understood that the system is not limited to particular embodiments and that it can be practiced or carried out in various ways.

The method provides a unique business method for information on products for funerals and advice on products for funeral. The business method also provides information and advice on financing of funerals that can be developed for use at time of need. Funeral homes have never provided any form of delayed payment for financing to families that do not have current cash to cover the $5000 cost of funerals. The method contemplates the creation of a business organization that provides information and products and, uniquely, provides financing for families.

The method includes providing advice to consumers on all aspects of funeral planning, including advice on handling the body; advice on handling grief; advice on transportation; financial advice; and other such advice. The advice is provided before, during, and after the funeral.

The method begins by providing products directly to the consumer, such as caskets, markers, cremation urns, and combinations thereof.

The caskets can be illustrated caskets, such as vinyl wrapped printed caskets. The illustrated caskets may have a customized decorative external surface by exhibiting a custom design that adheres seamlessly to the external surface of the casket. The casket designs may have a three-dimensional appearance. The caskets may appear as though hand painted directly onto the casket surface. The caskets can be metal caskets, wood caskets, or combinations thereof.

The designs on the illustrated caskets can include military images, religious images, images reflective of hobbies of the deceased, images reflective of interests of the deceased, images reflective of the career of the deceased, ethnic images, nationality images, or combinations of these images. The illustrated caskets may include images reflective of affinity groups of the deceased, such as the Elks, Veterans of Foreign War, The American Legion, unions, volunteer organizations, church memberships, or the like.

Markers stand above a grave site to indicate the grave site. The markers can be flat panels or a vertical monument, such as a granite engraved monument.

Cremation urns are the decorative urns for holding ashes.

These products are provided to the consumer by catalog, website, direct mail, television, radio, a hospice referral, a minister referral, an affinity group referral, a website link, or combinations of these information dispersing techniques.

The next step of the method is to give funeral planning advice, such as information on how to plan a funeral ceremony, how to select a minister, how to move a body, how to select a funeral location and how to finance the funeral using insurance, short term loans or other financial instruments.

Phone operators or website linkages will provide advice on funeral homes within a certain zip code or geographical location and provide advice on services available and prices. Similar advice will be available on the qualification for and arrangement for veteran's cemeteries. Additional advice will be available as state rules permit having a funeral in a home.

Once products and advice is given, the consumer responds to the information by making an order, a product inquiry, an advice inquiry, or some combinations of the response.

The consumer communication, request or inquiry is processed and consumer is provided with secondary information or secondary advice.

The secondary information or advice can be provided in person, by phone, by e-mail, by mail, by fax, or some combination of these.

The secondary advice can be funeral planning advice, such as how to announce the ceremony, how to dispose of a body, ways to handle grief, transportation of the body and mourners, and other post funeral advice. By method of disposition, the customer is proved with advice about the manner of disposition of a body, such as by cremation, by earth burial, by orbital burial, or by sea burial.

The ceremony location can also be discussed, such as whether to have the funeral ceremony in a funeral home, in a veteran's cemetery, in a church, in a home, on a beach, or in a park.

Another type of advice concerns financing. Financing advice includes advice on the amount that social security from the US government will provide. The operators or an interactive website will provide information on how to apply for payment from social security and other sources for funeral costs, including how to obtain veteran's administration payments; how to determine existing insurance benefits. How to locate available insurance polices to purchase and how to compare policy benefits; other financial advice includes information about trust fund institution and usage; financing from a commercial source at time of need; and how to ask for contributions from friends.

The method includes providing psychological advice on handling grief. Advice on grief can be dispensed by an on-line counseling service; an on-line religious support service; a live counselor by phone line; printed materials through the mail; or combination of these.

Another type of advice provided by the method is transportation advice, such as: on-line limousine booking services; on-line air booking web links; on-line hotel booking web links; on-line information about bereavement discounts on common carriers; on-line information on moving caskets in interstate commerce; on-line information on moving the deceased in interstate commerce; and combinations thereof.

Advice on funeral homes is also part of the method; this advice includes undertaking home information, and ceremony information. Advice of flower providers, intensive care nurses, ministers, and other care providers can also be provided with this method.

Once the information is presented on the products and advice via the various techniques, the consumer can pay for the products on advice. Preparing for others is also contemplated herein. Payment can be done by credit card, money order, a financing plan, check, or combinations thereof.

Ordered products and advice are then provided to a location designated by the consumer and then a follow-up contact is provided. The products can be shipped directly to a funeral home, church or other location permitted under state and federal regulations. The products can be provided using a common carrier or a freight forwarder.

The follow-up contact is provided in person, by phone, by e-mail, by mail, by fax, to the purchaser.

The method has been described in detail with particular reference to certain preferred embodiments thereof, but it will be understood that variations and modifications can be effected within the scope of the system, especially to those skilled in the art.

1. A method for providing products and information related to funerals directly to a consumer comprising:
a. providing products to a consumer comprising: caskets; markers; cremation urns; using a catalog; direct mail; a website; a television; a radio; a website link; or combinations thereof;
b. providing advice to the consumer comprising: funeral planning; funeral financing; and combinations thereof; and wherein the advice is provided by the website, direct mail, the television, the radio, a hospice referral, a minister referral, an affinity group referral, the website link, or combinations thereof;
c. receiving a consumer communication about the product, the advice, or both;
d. processing the consumer communication;
e. providing optional secondary advice to the consumer;
f. receiving payment from the consumer;
g. processing the payment;
h. providing the products or advice to a location or person designated by the consumer; and
i. providing follow-up contact after the product or advice is delivered.

2. The method of claim 1, wherein the consumer communication is an order, a product inquiry, an advice inquiry, or combinations thereof.

3. The method of claim 1, wherein the advice on funeral planning comprises: advice on ceremony location; advice on methods of disposition of a body; advice on handling grief, advice on transportation of the body and friends and family of the deceased; and combinations thereof.

4. The method of claim 3, wherein the advice on methods of disposition of the body includes advice on cremation, by earth burial, by orbital burial, or advice on sea burial.

5. The method of claim 3, wherein the ceremony location is advice on one or more funeral homes, on use of and location of veteran's cemeteries, advice on a local church, advice on funeral ceremonies at a home, a beach, a park, or combinations thereof.

6. The method of claim 1, wherein the funeral financing advice comprising: advice on how to obtain social security payments; veteran's administration payments; existing insurance benefits; available insurance policies; company benefits; funds from individuals; funds from trust funds; commercial source of money; and combinations thereof.

7. The method of claim 1, wherein the advice on handling grief comprises: on-line counseling services; on-line religious support; live counselor support phone lines; printed materials; and combinations thereof.

8. The method of claim 1, wherein the transportation advice comprises: on line limousine booking services; online air booking web links; online hotel booking web links for body movement and mourners; online information about bereavement discounts on common carriers; on-line information on moving caskets in interstate commerce; on-line information on moving the deceased in interstate commerce; and combinations thereof.

9. The method of claim 1, wherein the advice on funeral planning comprises: flower provider information, intensive care nurse information, minister information, and combinations thereof.

10. The method of claim 1, wherein the step of providing advice is performed in person, by phone, by e-mail, by mail, by fax, or combinations thereof.

11. The method of claim 1, wherein the caskets provided direct to the consumer are illustrated caskets.

12. The method of claim 11, wherein the illustrated caskets are vinyl wrapped printed caskets that comprise images that represent the deceased.

13. The method of claim 12, where the images comprise: military images; religious images; images reflective of hobbies of the deceased; images reflective of interests of the deceased; images reflective of the career of the deceased; images reflective of affinity groups of the deceased; ethnic images; nationality images; and combinations thereof.

14. The method of claim 13, wherein the affinity groups comprise: The Elks, Veterans of Foreign War, The American Legion, unions, volunteer organizations, church memberships, and combinations thereof.

15. The method of claim 11, wherein the caskets are metal caskets, wood caskets, or combinations thereof.

16. The method of claim 1, wherein the markers are flat panels or a vertical monument, and the markers stand above a grave site for indicating the grave site.

17. The method of claim 16, wherein the vertical monument is a granite engraved monument.

18. The method of claim 1, wherein the step of processing the payment is performed using a credit card, a money order, a financing plan, a check, or combinations thereof.

19. The method of claim 1, wherein the step of providing products to the location or person designated by the consumer is performed using a common carrier, a freight forwarder or combinations thereof.

20. The method of claim 19, wherein the location is a funeral home, a home, a church, or other location.

21. The method of claim 1, wherein the step of providing follow-up contact is performed in person, by phone, by e-mail, by mail, by fax, or combinations thereof.
